(19) United States
(12) Patent Application Publication
(10) Pub. No.: US 2002/0130959 A1
(43) Pub. Date: Sep. 19, 2002

(54) Venue customizable white balance digital camera system

(76) Inventor: James E. McGarvey, Hamlin, NY (US)

Correspondence Address: Thomas H. Close, Patent Legal Staff, Eastman Kodak Company, 343 State Street, Rochester, NY, 14650-2201, US

(21) Appl. No.: 09/759,475

(22) Filed: Jan. 12, 2001

(51) Int. Cl. H04N 5/228

(52) U.S. Cl. 348/223; 348/222

(57) ABSTRACT

A digital camera system is described that allows a user to capture an image including a white balance reference for a particular picture taking venue. The reference is used to determine a white balance setting for the venue. The white balance setting can be used for pictures taken at the venue at that time or saved for future picture taking sessions at that venue. The setting is saved in a removable, non-volatile memory that can be removed from and inserted into the digital camera. The memory can also be used to store the pictures captured at the venue associated with the saved setting. The white balance setting is saved in a file folder having a name allowing the user to correlate the file name with the particular venue. Several folders can be stored in the memory for different venues. The white balance setting can be determined by the digital camera or in an associated computer. The captured images can be white balance corrected in the digital camera or in the associated computer.

### CROSS REFERENCE TO RELATED APPLICATIONS

This application is related to U.S. application Ser. No. 09/224,547 entitled “Producing Panoramic Digital Images By Digital Camera Systems”, filed Dec. 31, 1998 by May et. al., having Kodak docket number 77,751 and the disclosure of which is herein incorporated by reference.

### BACKGROUND OF THE INVENTION

1. Field of the Invention

The present invention is directed to a system that allows a digital camera user to store white balance settings for different venues and, more particularly, to a system that will allow the user to return to the venue and retrieve the corresponding setting for use at the venue and use the retrieved setting to process the digital images.

2. Description of the Related Art

Digital cameras, such as the Kodak DC210+ camera, allow the user to select a variety of white balance settings. These include manual settings for different “average” illuminants, such as daylight or tungsten, as well as an automatic setting that determines the proper white balance setting for each captured picture using the pixel values of the image and possibly other camera information, such as the overall scene luminance level and the flash mode. In the DC210+, it is also possible to “lock” the automatically determined white balance setting after taking a first picture, so that subsequent pictures are taken with the same white balance correction value, as described in “Producing Panoramic Digital Images By Digital Camera Systems” noted above. This can be useful when taking a series of still images to be stitched together or viewed one after another. However, in these systems only one “locked” value is stored, and once the lock mode is disabled, or a new lock value is stored, the previous white balance value is erased and cannot be recalled by the camera.

News photographers, sports photographers, etc. often return to the same venue many times per month to take pictures of the same type of event (e.g. a hockey game or a baseball game). Each venue has different types of lighting which requires different white balance correction values to make white or neutral objects in the scene appear white in the captured image.

What is needed is a digital camera featuring a simple way for the user to accurately determine the appropriate white balance setting only one time at each venue, and then recall the setting the next time the user takes pictures at the same venue.

### SUMMARY OF THE INVENTION

It is an object of the present invention to provide a system that allows a user to set and save white balance settings for different venues.

It is another object of the present invention to provide a system that allows a user to retrieve and use white balance settings for different venues.

The above objects can be attained by a digital camera system that allows a user to capture an image including a white balance reference for a particular picture taking venue, determine a white balance setting from the image and save the white balance setting for future picture taking sessions at that venue. The setting is saved in a non-volatile memory that can be removed from and inserted into the digital camera. The white balance setting is saved in a file folder having an identifier or file name allowing the user to correlate the file name with the particular venue. The white balance setting can be determined by the digital camera or in an associated computer and the captured images can be corrected in the digital camera or in the associated computer.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of the components of the present invention.

FIG. 2 shows the boards of a preferred embodiment.

FIG. 3 depicts a flow of operations when setting, saving and using a white balance.

FIG. 4 shows a flow of operations of a white balance interface.

FIGS. 5A -5K illustrate GUI screens.

### DESCRIPTION OF THE PREFERRED EMBODIMENTS

A digital camera system, according to the present invention, typically includes a manual white balance setting feature that allows the white balance for a particular picture taking session or venue to be determined using a white card or other object positioned in the center of a captured image. White balance settings each for a different venue can be stored within a non-volatile memory in the digital camera of the invention. These settings can be used to process images captured at the venue in the digital camera before the images are stored or output. When future pictures are to be taken at the same venue, in accordance with the invention, the appropriate white balance settings can be retrieved and used, without having to repeat the manual white balance process. Other venue-image settings, such as image sharpness, image contrast, or image colorfulness, can also or alternatively be stored in the digital camera and later recalled and used. It is also useful to include other venue specific settings in a venue file, such as default exposure mode, shutter or aperture settings, focus mode, and other photographic settings. These typically vary with the type of sport or event. Retrieving and loading such settings would configure the digital camera to the best starting configuration but allow the photographer to vary individual settings as needed for the venue/event.

An alternative method of creating a white balance setting is by viewing any image captured at a venue on a computer screen and clicking on a neutral or white object in the scene. This is called “click balance” and it does not require the special image capture of a gray card but does require a picture with some neutral object in the scene.

It is also possible, for digital cameras with less processing power to store the white balance settings for the venue on a removable memory, such as a memory card, for later use in computer processing of taken images or to store a reference image having the white balance reference card therein for later white balance determination by the computer. That is, the determination of a white balance setting can be performed by the computer and stored in a file with an appropriate venue name on the removable memory card. The white balance correction for a set of pictures can also be performed by the computer using a setting selected at the venue and stored in association with a set of pictures on the card.

A digital camera system 10 according to the present invention includes a digital camera 12 typically having components as shown in the block diagram of FIG. 1. The digital camera 12 includes a lens 14, an image sensor 16, such as a CCD image sensor, a separate photo diode exposure detector 18, and an optical viewfinder 19 (associated display memory 20 and display 21) for composing the scene. In alternative embodiments, the image sensor 16 could also be used as the exposure detector. Once the picture is composed, the user presses a shutter button 22, which has two positions, S1 (partially depressed) and S2 (fully depressed). When S1 is enabled, the digital camera 12 performs automatic exposure determination via system 23 using the photo detector signal, which sets the f-number, exposure time, and analog gain level. The digital camera exposure control may operate as described in Kodak U.S. Pat. No. 5,610,654 entitled “Automatic Camera Exposure Control Using Variable ISO Sensor” the disclosure of which is herein incorporated by reference.

A digital camera control processor and timing generator or control 24 then generates the control signals that expose the image sensor 16 via shutter drive 25 and shutter 26, and clock out the sensor signal. The analog signal from the sensor 16 is processed in an analog signal processor 27 (which performs correlated double sampling), A/D converted by converter 28, and stored in frame memory 29. An image processor 30 includes and performs color filter array interpolation, white balance correction, color correction, edge enhancement, JPEG image compression, and file formatting. The resulting image is stored in an image file, such as a JPEG interchange format file (.JPG), on a removable memory card 32 through an interface 31.

When the user sets the white balance to the “automatic” mode, the white balance settings to be used for each image can be individually determined automatically by a white balance determination processor 34, stored in white balance memory 36 and used to correct the white balance as described in Kodak U.S. Pat. No. 5,659,357, entitled “Auto White Adjusting Device”, by Miyano the disclosure of which is herein incorporated by reference. However, this can lead to white balance errors since the algorithm can be fooled by colored objects in the scene.

For best results, the proper white balance setting for a particular venue is determined by photographing a large white or gray white balance reference card positioned in the scene to be photographed. For a sports venue, this means holding the card on the ice of a hockey rink or in the middle of a baseball field. Typically, the photographer does not want to do this each time they take pictures at a given venue. To avoid this problem, the present invention allows the white balance obtained for the venue to be saved.

The present invention allows the user to perform the white card photography only once per venue. The white balance setting for each venue is determined and stored in a file named by the user. The file can be created/located in the camera white balance memory 36 and/or in the removable memory card 32 and duplicated on a separate computer 38, such as a desktop computer, available to the user. When the user returns to the venue, the user can select the named white balance file, and that file will be used to perform the white balance correction for future images until the setting is canceled or changed. The user can also transfer the setting to additional digital cameras through the computer 38 or removable memory card 32, so that the same setting determined by one digital camera can be used by other digital cameras that are photographing the same event.

A preferred configuration for the above-described components in a professional digital camera 60 is depicted in FIG. 2. A camera body 62 including a lens, an aperture, a shutter (not shown), is coupled to a computer board 64 and an imager board 66. A captured image including the white balance reference is provided to a processing board 68 where white balance determination processing is performed. The resulting white balance is stored in a memory 70 of computer board 64 for processing pictures taken at the current venue and in one or more non-volatile memory cards inserted into one of several card memory slots 72 for current or future picture taking sessions at this venue. A display board 74 controls the display and provides an interface to various control buttons.

Obtaining a white balance setting involves capturing an image of a white balance reference in the scene and it can sometimes be difficult to accomplish this when the user arrives at a venue during the particular entertainment, such as arriving after a football game has started. With this problem in mind, white balance capture and image processing can be performed in a number of different scenarios. The user can go to a venue in advance and capture a white balance for the venue, store the white balance image, process the image using the computer 38, store the white balance for the venue on the removable memory card 32 and use the white balance from the removable memory card 32 to process venue images in the digital camera at the venue when the user returns to the venue so that the images can be immediately sent for publication. Alternatively, the user can capture the venue images, associate the images with the white balance setting and process the images using the computer 38. Another scenario involves capturing the white balance reference image at the venue event, processing the reference image in the digital camera at the event to obtain the white balance, storing the white balance in a file on the removable memory card 32 with an associated venue/file name, capturing venue event images, and processing the event images in the digital camera using the white balance captured at the event. Another alternative is to use the white balance captured/determined at the venue event to later process the images in the computer 38.

The white balance capture, storage and use operations of the present invention are depicted in FIG. 3 for the scenario where the user visits the venue ahead of time, and the digital camera includes sufficient processing power to determine a white balance and process the captured images with a stored white balance setting. Typically the user will go to a first venue (operation 102) and take a photograph of a neutral object in the scene (operation 104), such as the neutral white balance reference card discussed above, under the expected lighting conditions. At this time the user will typically store this image in memory of the removable memory card 32. The image is then processed (operation 106) by the digital camera to determine the white balance settings. Alternatively, the image can be processed to determine the white balance on the computer 38. The user then uses a digital camera graphical user interface (GUI) and associated digital camera buttons (not shown) to select a mode for storing the white balance setting (operation 108). This operation 108 can also be performed in computer 38. The user, via the GUI, enters (or selects/confirms) a file name for the white balance setting (operation 110) and the setting is stored in removable memory card 32 (operation 112) which, if located in the computer 38, would be removed and inserted into the digital camera. The naming would also occur in the computer 38 when the white balance processing is not performed by the digital camera. The user the goes to a second venue (operation 114) and repeats the operations noted above (operation 116). The user goes to the next/last venue (operation 118) and repeats the operations (operation 120).

When the user returns to the first venue (operation 122), the user selects the mode for white balance setting in the digital camera (operation 124) and selects the file name of the first venue (operation 126). The digital camera accesses the memory card 32, and obtains the white balance settings from the file using the file name (operation 128). The user takes new photographs at the venue event (operation 130) and the digital camera applies the white balance setting to correct each photograph (operation 132) where each corrected photograph is stored in memory card 32. The images can then be output by removing the memory card 32 and downloading the images using the computer 38 or, if the digital camera has an output port, downloading over a connection to the port.

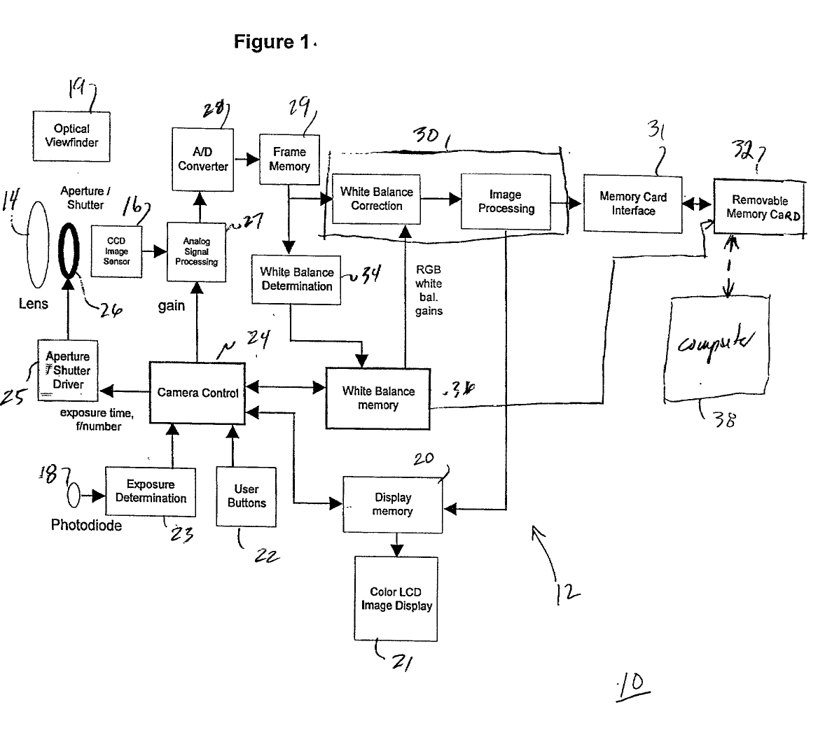

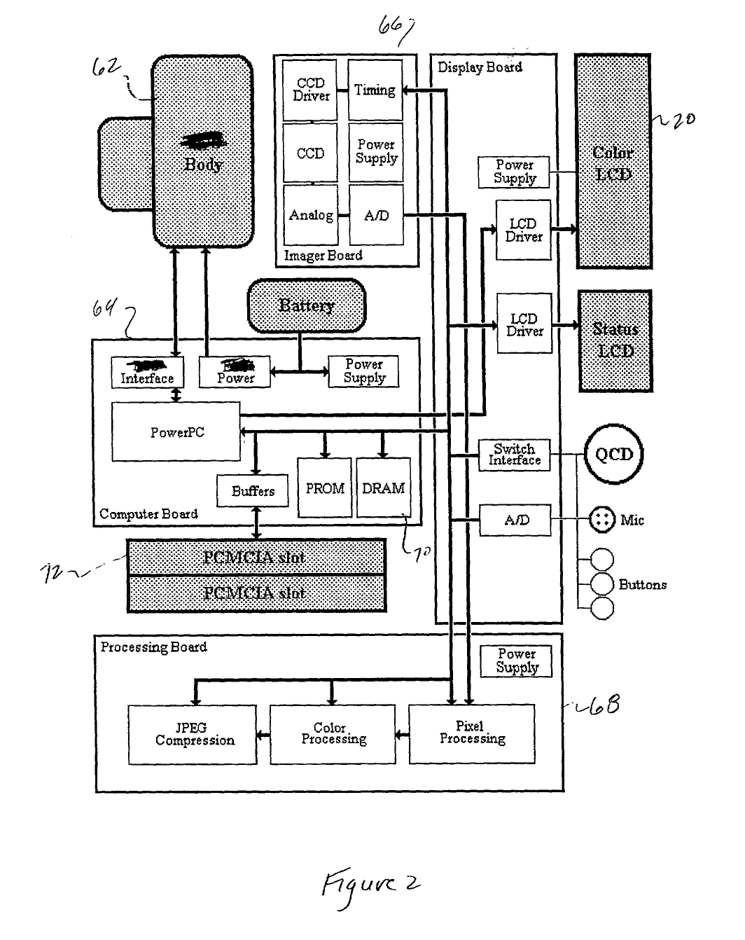

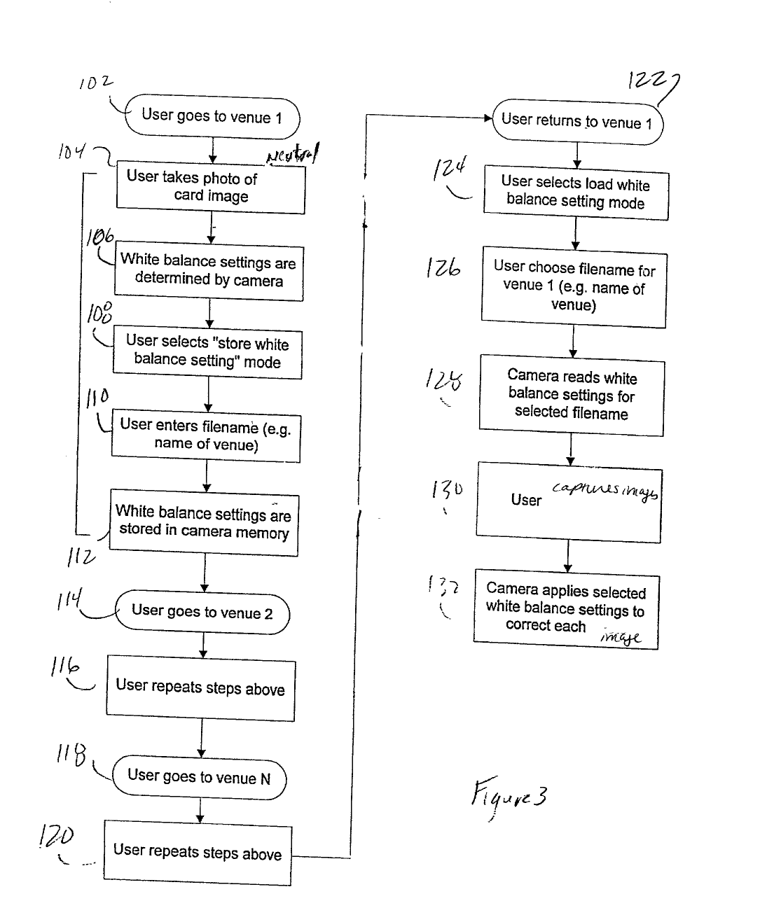

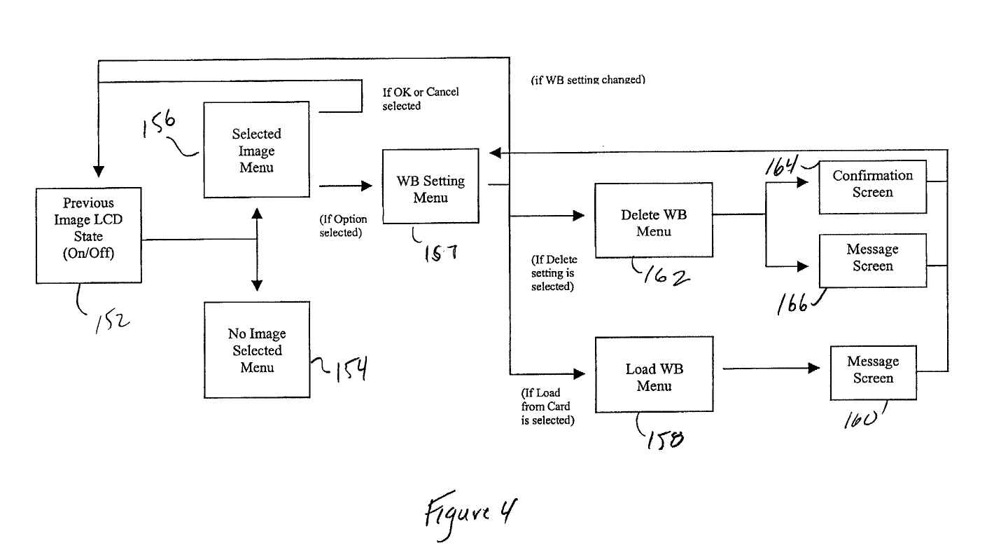

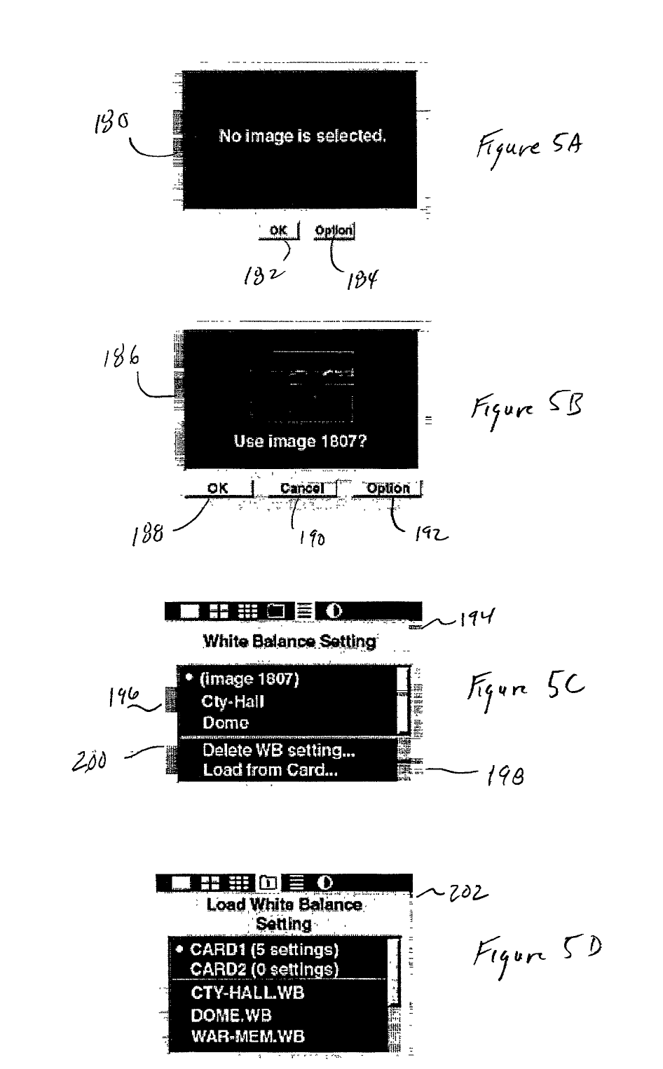

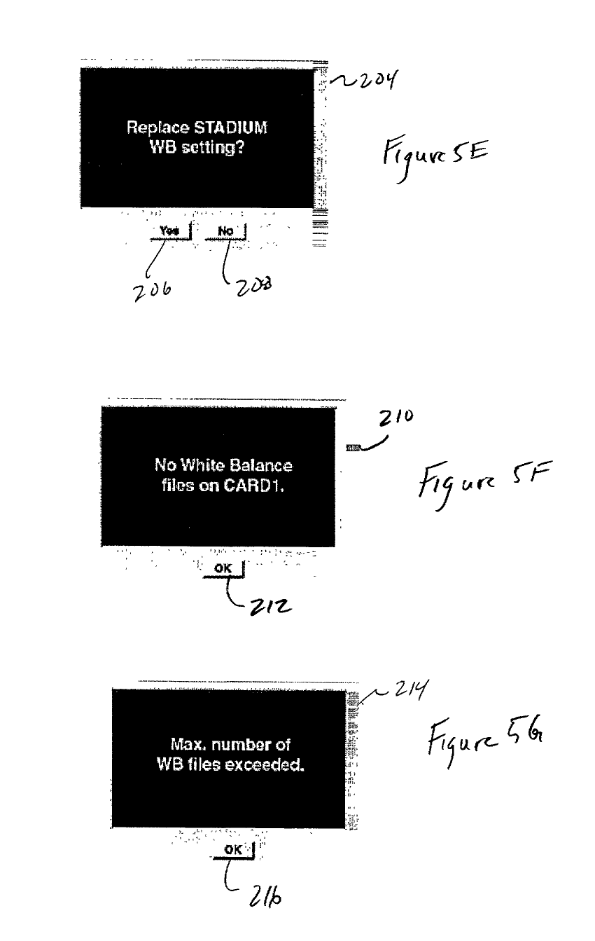

FIG. 4 depicts the flow of operations of white balance management within the digital camera. User actions for the white balance function occur through activation of a white balance button on the digital camera. This button is preferably a physical button but could be a GUI button projected onto the digital camera display and activated via a pointer moved by physical buttons.

The buttons discussed hereinafter are preferably GUI buttons that are pointed to and activated by the physical buttons depicted in FIG. 2. The buttons could, of course, be physical buttons initiating the appropriate functions.

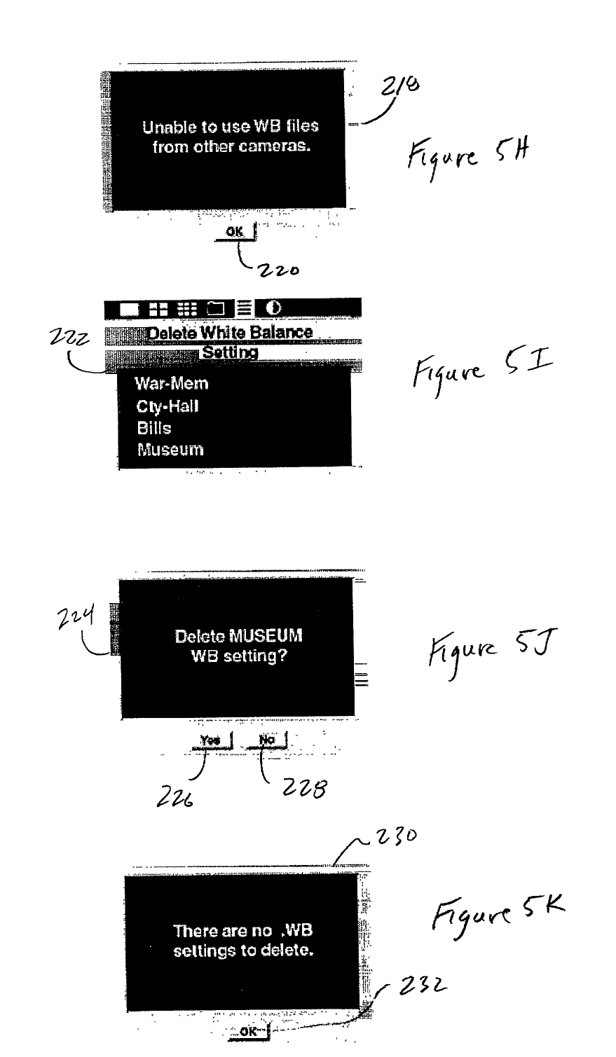

When a determination is made that there are no images in a currently active camera file or folder stored on one of the detachable memory cards 32/72 and the white balance button is pressed (operation 152), a message screen 180 (see FIG. 5A) indicating that no image is selected is displayed on the display 21 (operation 154). Pressing the “OK” button 182 turns off the LCD. Pressing the “Option” button 184 presents a White Balance Setting screen 194 (see FIG. 5C) (operation 156).

When the currently active folder contains images and the white balance button is pressed, an image selection screen 186 (see FIG. 5B) portraying the currently active image and the query “Use image n?” is displayed, where n is the number assigned to that image by the digital camera control system. When the digital camera does not have the capability of entering an alphanumeric name through a keyboard or GUI, the number n is also the name of the folder or file containing the white balance setting. If the image LCD is off when the white balance button is pressed, it will be turned on and the above mentioned screen displayed. Pressing the “OK” button 188 loads the white balance values associated with that image. If the image LCD was on, the previously active function or menu is displayed. If the image LCD was off, this display is returned to the off state. Pressing the “Cancel” button 190 returns the user to the previously displayed function or menu; if the image LCD was off, this display is turned off. Pressing the “Options” button 192 displays a White Balance Setting Menu 194 (see FIG. 5C). This menu displays a number of items, as described below.

When the “Option” button 192 on the “Use Image n?” menu screen (FIG. 5B) is pressed, a screen 194 (FIG. 5C) presenting a menu of White Balance options is presented (operation 157). The items displayed in this screen 194 include: a list 196 of white balance files that exist in the digital camera; an option 198 to load settings from a memory card; and an option 200 to delete white balance settings from the digital camera. The currently active white balance setting is noted by a “.” symbol. Choosing any of the white balance settings via the control buttons of the digital camera activates that white balance value, and returns the image LCD to its previous state. The selected white balance setting persists until changed by the user. Choosing the “Load from CARD . . . ” option 198 results in the digital camera producing (operation 158) a white balance sub-menu 202 (see FIG. 5D) that offers options for selecting white balance files that may exist on either or both of the removable memory cards in the digital camera. Selecting one of the displayed white balance options loads the white balance values from that file into memory, and returns the user to the updated White Balance Setting menu 194 (FIG. 5C), which displays the name of the just-loaded white balance file. If an attempt is made to load a white balance setting whose name matches an already-existing setting, a message screen 204 (see FIG. 5E) will be displayed (operation 160). This screen poses the question whether or not to replace the existing file. Pressing the “Yes” button 206 loads/replaces the white balance setting. Pressing the “No” button 208 does not load the file from the card and returns the user to the White Balance Setting menu (FIG. 5C).

If a memory card having no white balance files is accessed, a no file message screen 210 (FIG. 5F) will be displayed. Pressing the “OK” button 212 returns the user to the White Balance Setting menu 194. If the maximum number of white balance files allowed is reached and an attempt is made to load another file, a maximum number message screen 214 (FIG. 5G) is displayed. Pressing the “OK” button 216 returns the user to the White Balance Setting menu 194. In such a situation, to load additional white balance files into camera memory, the user must first delete one or more white balance files from the digital camera. If the maximum number of white balance files already exists when the “Load from card . . . ” option in the White Balance Setting screen 194 is selected, the message screen 214 (FIG. 5G) is displayed.

Generally, each digital camera can utilize white balance files generated by that digital camera only. If an attempt is made to load white balance files from another digital camera, the invalid file message 218 (FIG. 5H) is displayed. Pressing the “OK” button 220 returns the user to the White Balance Setting menu 194.

Choosing the “Delete WB setting . . . ” option in the White Balance menu 194 displays (operation 162) a white balance sub-menu screen 222 (FIG. 5I) with options for deleting white balance files that exist in the digital camera. Selecting one of the white balance settings from this sub-menu displays (operation 164) a confirmation screen 224 (FIG. 5J). Selecting the “Yes” option 226 deletes the selected setting from the digital camera and returns the user to the White Balance Setting menu 194. Selecting the “No” option 228 does not delete the selected setting and returns the user to the White Balance Setting menu 194. If the currently active white balance setting is deleted, the current setting is set to “Untitled.”

If there are no white balance settings in the digital camera and the “Delete WB setting . . . ” option 200 is selected, a no setting message 230 (FIG. 5K) is displayed (operation 166). Pressing the “OK” button 232 returns the user to the White Balance Setting screen 194 (see FIG. 5C).

The present invention has been described with respect to communicating with the digital camera via memory cards. It is possible to transfer the settings from one digital camera to another, or to and from a computer, using a wired or wireless communication link.

The present invention has been described with respect to determining settings from a white balance reference. The present invention can include the capturing of a calibration image of a color chart instead of just a gray card. The digital camera or computer software would locate and analyze the patches in the color chart and create both a custom white balance and color correction matrix for the venue with the remainder of the process being the same.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

Parts List

| | |
|---|---|
| 10 | System |
| 12/60 | Digital Camera |
| 14 | Lens |
| 16 | Sensor |
| 18 | Diode |
| 19 | Viewfinder |
| 20 | Display memory |
| 21 | Display |
| 22 | Buttons |
| 23 | Exposure determination unit |
| 24 | Camera control unit |
| 25 | Aperture driver |
| 26 | Aperture |
| 27 | Analog processing unit |
| 28 | A/D converter |
| 29 | Frame memory |
| 30 | Color processing unit |
| 31 | Interface |
| 32 | Removable memory card |
| 34 | White balance determination unit |
| 36 | White balance memory |
| 38 | Computer |
| 62 | Body |
| 64 | Computer board |
| 66 | Imager board |
| 68 | Processing board |
| 70 | Memory |
| 72 | Memory slots |
| 74 | Display board |
| 102-132 | Setting and processing operations |
| 152-166 | White balance file management operations |
| 180-232 | Graphical user interface display elements |

What is claimed is:

1. A white balance picture correction process, comprising the steps of:
determining a white balance digital camera processing setting for a picture taking venue at a visit to the venue;
saving the setting for the venue; and
correcting pictures taken at a subsequent visit to the venue with the saved setting.

2. A process as recited in claim 1, wherein said determining step uses a white balance reference card in a scene of the venue.

3. A process as recited in claim 1, wherein said saving step comprises assigning an identifier to the setting.

4. A process as recited in claim 3, wherein said identifier comprises a file name.

5. A process, comprising the steps of:
determining a white balance digital camera processing setting for a picture taking venue at a visit thereto;
saving the setting for the venue in a file using a file name; and
correcting pictures taken at a subsequent visit to the venue with the saved setting.

6. A process as recited in claim 5, wherein said saving step comprises storing the setting in a removable, non-volatile memory.

7. A process as recited in claim 5, wherein said determining step is performed in a digital camera.

8. A process as recited in claim 7, wherein said correcting step is performed in a digital camera.

9. A process as recited in claim 7, wherein said correcting step is performed contemporaneous with taking of the pictures at the venue.

10. A process as recited in claim 5, wherein settings are saved for plural venues.

11. A process as recited in claim 10, wherein said correcting step is performed for subsequent visits to the venues.

12. A process as recited in claim 5, wherein said setting further comprises, an image sharpness setting, a contrast setting and a colorfulness setting.

13. A process as recited in claim 5, wherein the setting further comprises a color correction matrix.

14. A process, comprising the steps of:
determining a white balance digital camera processing setting for a picture taking venue at a visit thereto using a white balance reference card positioned in a venue scene;
saving the setting for the venue; and
correcting pictures taken at a subsequent visit to the venue with the saved setting.

15. A process, comprising the steps of:
determining an image processing setting for a picture taking venue; and
saving the setting for the venue.

16. A process as recited in claim 15, wherein said setting comprises a white balance setting.

17. A process as recited in claim 15, wherein said setting comprises an image sharpness setting.

18. A process as recited in claim 15, wherein said setting comprises an image contrast setting.

19. A process as recited in claim 15, wherein said setting comprises an image colorfulness setting.

20. A process as recited in claim 15, wherein said setting comprises one of an image white balance setting, an image sharpness setting, a contrast setting and a colorfulness setting.

21. A process, comprising the steps of:
determining, in a digital camera, image processing settings for picture taking venues during initial visits to the venues using a reference card placed in a scene at the venues;
assigning a file name identifiers to the settings;
saving the settings in a removable, non-volatile memory using the file name identifiers where the setting comprises an image white balance setting, an image sharpness setting, a contrast setting and a colorfulness setting; and
correcting pictures taken at the venues in subsequent visits to the venues, in the digital camera, with the saved settings contemporaneous with taking of the pictures at the venue.

22. An apparatus, comprising:
a system obtaining a white balance setting for a venue; and
a storage storing the white balance setting for the venue.

23. An apparatus as recited in claim 22, wherein said system comprises a digital camera.

24. An apparatus as recited in claim 23, wherein said digital camera corrects pictures taken using the setting.

25. An apparatus as recited in claim 23, wherein said digital camera obtains the white balance setting by capturing an image including a white balance reference and determines the white balance setting.

26. An apparatus as recited in claim 22, wherein said storage comprises a removable, non-volatile memory.

27. A computer readable storage controlling a computer controlled digital camera via a white balance setting and a file name corresponding to the white balance setting.

28. A digital still camera, comprising:
a sensor capturing images in an initial visit to a venue and a subsequent visit to the venue;
a lens for imaging light onto the sensor;
a white balance determination processing unit determining a white balance correction value from a captured image of the initial visit;
a memory storing the white balance correction value from the initial visit; and
a white balance correction processing unit applying the white balance correction value to the captured image of the subsequent visit producing a white balance corrected image.

29. A digital still camera, comprising:
a sensor capturing images;
a lens for imaging light onto the sensor;
a white balance determination processing unit determining white balance correction values from the captured images;
a memory storing a plurality of the white balance correction values;
a selector choosing one of the plurality of white balance correction values; and
a white balance correction processing unit applying a selected one of the white balance correction values to a plurality of captured images producing white balance corrected images.

30. A camera as recited in claim 29, wherein the memory comprises a non-volatile removable memory card that can be used to transfer correction values to other devices.

31. A camera as recited in claim 29, wherein the camera comprises a user interface for naming the plurality of white balance correction values and for selecting from among a plurality of named white balance correction values.

32. A digital still camera, comprising:
a sensor capturing images;
a lens for imaging light onto the sensor;
a memory storing a plurality of the white balance correction values;
a selector operable by a user in choosing one of the plurality of white balance correction values; and
a white balance correction processing unit applying a selected one of the white balance correction values to a plurality of captured images producing white balance corrected images.
